(19) United States
(12) Patent Application Publication
(10) Pub. No.: US 2026/0261455 A1
(43) Pub. Date: Sep. 3, 2026

(54) CHANNEL ESTIMATION METHOD AND INFORMATION PROCESSING APPARATUS

(71) Applicant: Fujitsu Limited, Kawasaki-shi (JP)

(72) Inventors: Yoshinobu IIMURA, Kawasaki (JP); Masatoshi OGAWA, Zama (JP); Takashi SEYAMA, Kawasaki (JP); Ryota KOSAKA, Kawasaki (JP); Nobukazu FUDABA, Yokohama (JP)

(73) Assignee: Fujitsu Limited, Kawasaki-shi (JP)

(21) Appl. No.: 19/539,877

(22) Filed: Feb. 13, 2026

(30) Foreign Application Priority Data
Feb. 28, 2025 (JP) 2025-031877

(51) Int. Cl. H04L 25/02; H04L 27/26

(52) U.S. Cl. CPC H04L 25/0224; H04L 25/0202; H04L 25/0212; H04L 25/022; H04L 25/0232; H04L 27/2647

(57) ABSTRACT

A processing unit determines, using a first function representing an expected value of the number of bit errors in a transmission signal restored from a received signal using an estimated value of a channel, a first value of the channel that minimizes the expected value, and determines a first correction value for a first estimated value of the channel using a second function for obtaining a correction value whose product with a true value of the channel is the first value.

### CROSS-REFERENCE TO RELATED APPLICATION

This application is based upon and claims the benefit of priority of the prior Japanese Patent Application No. 2025-031877, filed on Feb. 28, 2025, the entire contents of which are incorporated herein by reference.

### FIELD

The embodiments discussed herein relate to a channel estimation method and an information processing apparatus.

### BACKGROUND

In wireless communication such as an orthogonal frequency division multiplexing (OFDM) scheme, a received signal may deteriorate due to fading and a bit error may occur in a restored transmission signal. Therefore, a channel value reflecting fading characteristics is estimated and a transmission signal using a channel estimation value and a received signal.

Conventionally, there has been proposed a technique for estimating a channel coefficient based on a signal outputted from a filter that suppresses a signal component in a specific frequency band of a received signal in a wireless communication system (see, for example, Japanese Laid-open Patent Publication No. 2013-141142). In addition, a technique for correcting a channel estimation value by multiplying the channel estimation value by a carrier frequency offset estimation value has been proposed (see, for example, U.S. Patent Application Publication No. 2004/0156422). Furthermore, a technique has been proposed in which a weighting coefficient that minimizes a bit error rate when maximum likelihood detection is performed in a receiver is calculated, and a modulated signal is multiplied by the weighting coefficient to output an obtained signal as a transmission signal (see, for example, Japanese Laid-open Patent Publication No. 2007-306532). Moreover, a technique for obtaining the number of subcarriers that minimizes an average bit error rate has been proposed (see, for example, U.S. Patent Application Publication No. 2009/0147749).

In addition, a method for estimating a channel value using a machine learning model based on a deep neural network (DNN) has been proposed (for example, see Mehran Pourahmadi, Ali Mirzaei, and Soltani, Vahid Hamid Sheikhzadeh, “Deep Learning-Based Channel Estimation”, IEEE COMMUNICATIONS LETTERS, VOL. 23, NO. 4, April 2019).

### SUMMARY

In one aspect, there is provided anon-transitory computer-readable recording medium storing therein a computer program that causes a computer to perform a process including: determining, by using a first function representing an expected value of a number of bit errors in a transmission signal restored from a received signal using an estimated value of a channel, a first value of the channel that minimizes the expected value; and determining a first correction value for a first estimated value of the channel using a second function for obtaining a correction value whose product with a true value of the channel is the first value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a channel estimation method according to a first embodiment;

FIG. 2 illustrates an example of a restored transmission signal;

FIG. 3 is a view for describing a basic unit of a signal in the OFDM scheme;

FIG. 4 illustrates an example of channel estimation in the OFDM scheme;

FIG. 5 illustrates an example of the number of bit errors;

FIG. 6 is a block diagram illustrative of an example of hardware of an information processing apparatus;

FIG. 7 is a block diagram illustrative of an example of the functions of the information processing apparatus;

FIG. 8 illustrates the relationship between a transmission signal and a restored transmission signal;

FIG. 9 illustrates the relationship between a transmission signal and a restored transmission signal at the time of a=1;

FIG. 10 illustrates the relationship between a transmission signal and a restored transmission signal at the time of a>1;

FIG. 11 illustrates an example of generating a function a*(h, σ);

FIG. 12 illustrates an example of correcting an estimated value of a channel;

FIG. 13 is a flow chart illustrative of a processing procedure of a channel estimation method according to a second embodiment; and

FIG. 14 illustrates an evaluation result indicative of the relationship between the number of parameters of a machine learning model and the number of bit errors.

### DESCRIPTION OF EMBODIMENTS

Even if a value of a channel is accurately estimated by using the machine learning model, an estimated value of the channel that minimizes an expected value of the number of bit errors may be different from a true value of the channel.

Embodiments of the present disclosure will now be described with reference to the drawings.

### First Embodiment

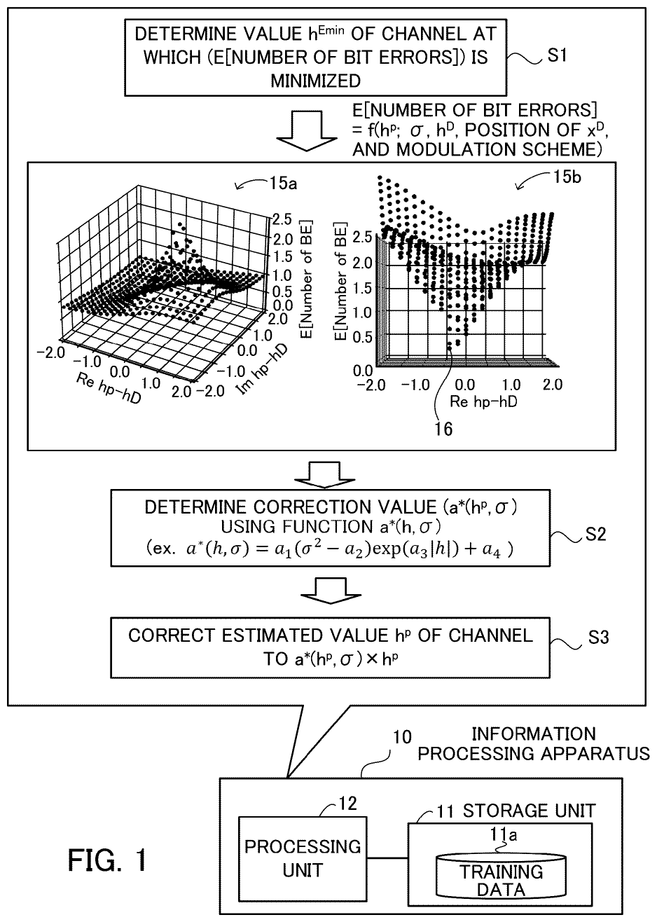

FIG. 1 illustrates an example of a channel estimation method according to a first embodiment. The channel estimation method according to the first embodiment is a method for obtaining a channel estimation value capable of reducing the number of bit errors.

FIG. 1 illustrates an information processing apparatus 10 for implementing the channel estimation method according to the first embodiment. The information processing apparatus 10 implements the channel estimation method according to the first embodiment, for example, by executing a channel estimation program.

The information processing apparatus 10 includes a storage unit 11 and a processing unit 12. The storage unit 11 is, for example, a memory or a storage device included in the information processing apparatus 10. The processing unit 12 is, for example, a processor included in the information processing apparatus 10. The information processing apparatus 10 may include a plurality of processors. A certain process and another process among a plurality of processes by the information processing apparatus 10 may be performed by different processors.

The storage unit 11 stores training data 11a. The training data 11a include, for example, a value regarding noise in a propagation path of a transmission signal, a true value of a channel, a position of the transmission signal in a complex plane, and a modulation scheme.

The relationship between a received signal (y^{D}) and a transmission signal (x^{D}) is expressed by Expression (1).

$${y}^{D} = {h}^{D} {x}^{D} + n , n ∼ CN ( 0 , 2 {σ}^{2} ) \qquad ( 1 )$$

In Expression (1), h^{D} represents a true value of a channel and n represents a noise value of a complex number. “n~CN (0, 2σ²)” means that n follows a complex normal distribution with a mean value=0 and a variance=2σ². 2σ²=10^{-SNR[db]/10}. SNR is a signal-to-noise ratio.

In zero-forcing (ZF) demodulation, a restored transmission signal (x^{ZF}) is expressed by the following Expression (2) using y^{D} and a channel estimation value (h^{p}).

$${x}^{ZF} = \frac{{y}^{D}}{{h}^{p}} = \frac{{h}^{D}}{{h}^{p}} {x}^{D} + \frac{n}{{h}^{p}} \qquad ( 2 )$$

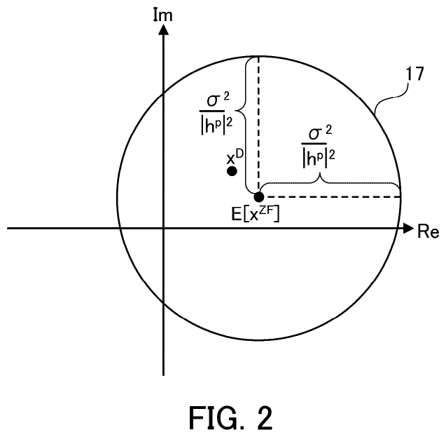

FIG. 2 illustrates an example of a restored transmission signal. In FIG. 2, an expected value (E[x^{ZF}]) of a restored transmission signal is indicated together with a value of x^{D} on a complex plane in which a horizontal axis is a real axis (Re) and a vertical axis is an imaginary axis (Im). In FIG. 2, a circle 17 represents the magnitude of a variance by x^{ZF}.

When a value of x^{ZF} is divided into a real part (Re x^{ZF}) and an imaginary part (Im x^{ZF}), the value of x^{ZF} follows a two-dimensional normal distribution represented by Expression (3).

$$[ \begin{matrix}Re {x}^{ZF} \\ Im {x}^{ZF}\end{matrix} ] \sim N ( [ \begin{matrix}Re ( {h}^{D} {x}^{D} / {h}^{p} ) \\ Im ( {h}^{D} {x}^{D} / {h}^{p} )\end{matrix} ] , {H}^{r} Σ {H}^{{r}^{⊤}} ) \qquad ( 3 )$$

In Expression (3), H^{r}ΣH^{rT} is expressed as Expression (5) using Expression (4).

$${H}^{r} = \frac{1}{{( Re {h}^{p} )}^{2} + {( Im {h}^{p} )}^{2}} [ \begin{matrix}Re {h}^{p} & Im {h}^{p} \\ - Im {h}^{p} & Re {h}^{p}\end{matrix} ] \qquad ( 4 )$$

$${H}^{r} Σ {H}^{{r}^{⊤}} = \frac{1}{Re {h}^{p 2} + Im {h}^{p 2}} [ \begin{matrix}{σ}^{2} & 0 \\ 0 & {σ}^{2}\end{matrix} ] \qquad ( 5 )$$

For example, σ in Expression (1) is used as a value regarding noise included in the training data 11a.

By the way, in the OFDM scheme, a basic unit of a signal (referred to as a resource block) is determined at constant time intervals and frequency intervals.

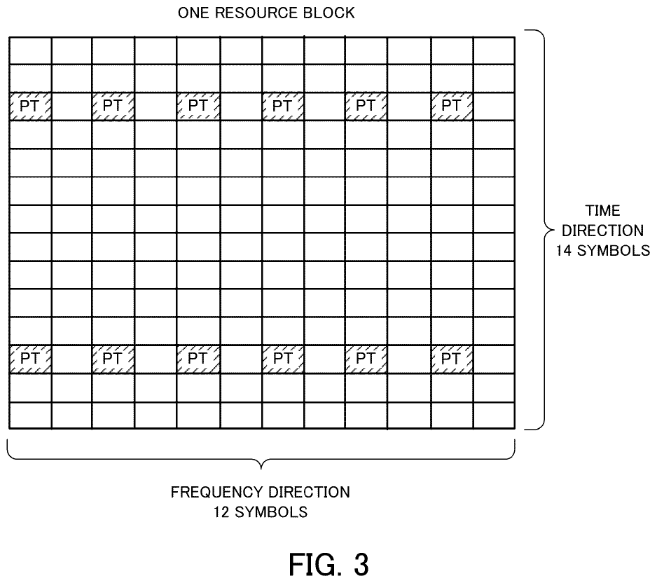

FIG. 3 is a view for describing a basic unit of a signal in the OFDM scheme. One resource block consists of a signal of 14×12 symbols, that is to say, 12 symbols in a frequency direction and 14 symbols in a time direction.

Furthermore, in the OFDM scheme, a signal of a symbol at a predetermined position is a pilot signal (indicated by “PT” in FIG. 3). The pilot signal includes a value (fixed value) of x^{D} known to the receiving side. Therefore, a least square (LS) estimation value (h^{ls}) of a channel in the symbol of the pilot signal is expressed as h^{ls}=y^{D}/x^{D}.

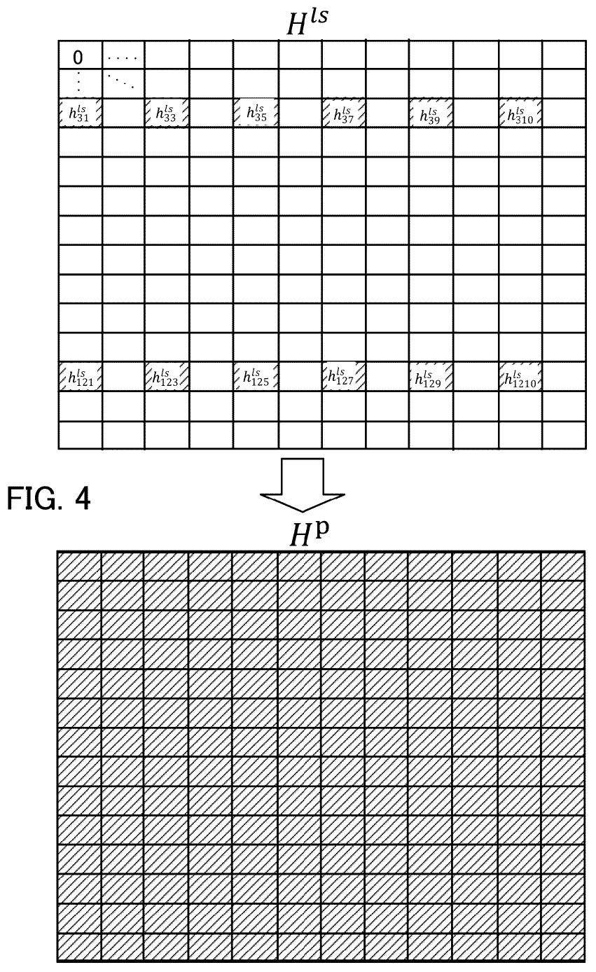

FIG. 4 illustrates an example of channel estimation in the OFDM scheme. As a method for obtaining a matrix H^{p} of a channel estimation value of the entire resource block, there is a method for performing two-dimensional linear interpolation of a matrix H^{ls} in which h^{ls} (h^{ls}₃₁, h^{ls}₃₃, and the like in FIG. 4) in symbols of the pilot signal are used and channel estimation values of the other symbols are set to 0.

In addition, as a more accurate estimation method, there is a method for obtaining a matrix H^{p} by regarding the matrix H^{ls} as a low-resolution image and performing high-resolution processing using a DNN-based machine learning model. The machine learning model is trained so that the Euclidean distance (∥H^{D}-H^{p}∥₂) between the matrix H^{p} and a matrix H^{D} representing a true value of the channel is minimized.

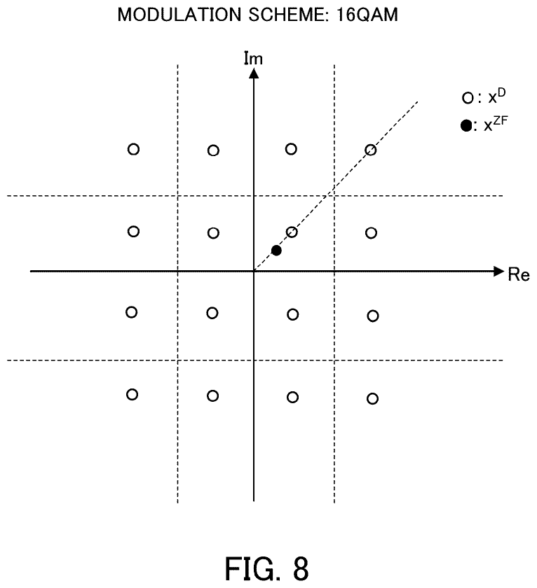

However, even if a value of the channel is accurately estimated using the machine learning model, an estimated value of the channel that minimizes an expected value of the number of bit errors may be different from the true value of the channel. The reason for this will be described later (see FIGS. 8 to 10).

Therefore, as one method, it is conceivable to regard a matrix of channel values in which an expected value of a bit error is minimized as an image and train the machine learning model so that the Euclidean distance between this matrix and the matrix H^{p} is minimized.

However, as described above, the machine learning model for channel estimation restores a true image (matrix H^{D}) from the low-resolution image (matrix H^{ls}). For this reason, training of the machine learning model for restoring an image different from the true image is not sufficiently performed, which may result in an increase in the number of bit errors.

Therefore, in the channel estimation method according to the first embodiment, the processing unit 12 performs the following processing. For example, the processing unit 12 implements the channel estimation method in accordance with a processing procedure indicated by the channel estimation program. The processing procedure of the channel estimation method implemented by the processing unit 12 is as follows.

Step S1: The processing unit 12 uses a first function representing an expected value of the number of bit errors (E [the number of bit errors]) in a transmission signal restored from a received signal using a channel estimated value to determine a first value of the channel at which the expected value is minimized. Hereinafter, the first function is referred to as a bit error function. Furthermore, the first value is indicated by h^{Emin}. The transmission signal is restored from the received signal using the channel estimated value (h^{p}) as in Expression (2).

The expected value of the number of bit errors changes depending on a value of h^{p}, a modulation scheme, a value of σ (or SNR), a value of h^{D}, and a position of x^{D} on the complex plane.

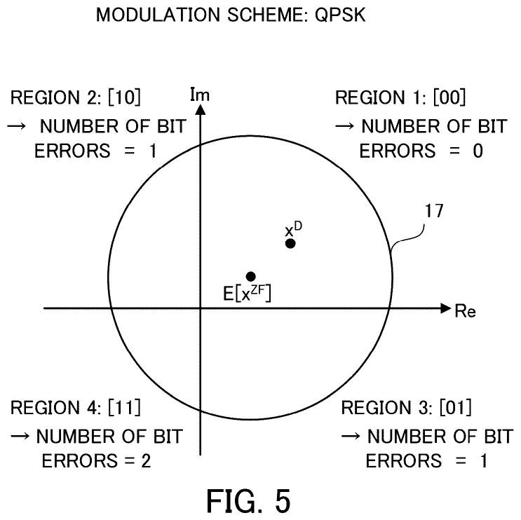

FIG. 5 illustrates an example of the number of bit errors. FIG. 5 illustrates an example in which a modulation scheme is quadrature phase shift keying (QPSK) and a value of x^{D} is located in a region 1 on the complex plane.

If the modulation scheme is QPSK, then a bit value of x^{D} is represented by which of regions 1 to 4 on the complex plane x^{D} is located. If x^{D} is located in the region 1 in which a real part and an imaginary part are both positive, then a bit value is “00”. If x^{D} is located in the region 2 in which a real part is negative and an imaginary part is positive, then a bit value is “10”. If x^{D} is located in the region 3 in which a real part is positive and an imaginary part is negative, then a bit value is “01”. If x^{D} is located in the region 4 in which a real part and an imaginary part are both negative, then a bit value is “11”. A bit value is determined in this way by the position of x^{D} on the complex plane.

If the expected value E[x^{ZF}] of the restored transmission signal is located in the same region as x^{D}, then no bit error occurs. If the expected value E[x^{ZF}] of the restored transmission signal is located in a region different from x^{D}, then a bit error occurs. For example, as illustrated in FIG. 5, if E[x^{ZF}] is located in the same region 1 as x^{D}, then the number of bit errors=0. If E[x^{ZF}] is located in the region 2 or 3, then the number of bit errors=1. If E [x^{XF}] is located in the region 4, then the number of bit errors=2.

When x^{D} is located in the region 1 on the complex plane, the expected value of the number of bit errors (E[number of bit errors]) is expressed as E[number of bit errors]=0×p₁+p₂+p₃+2×p₄, where pᵢ is the probability that a value of x^{ZF} falls within a region i.

The pᵢ is calculated using the above two-dimensional normal distribution. For example, p₁ is expressed by Expression (6) using an error function erf.

$${p}_{1} = \frac{1}{4} ( erf ( \frac{∞ - Re {hx}^{p}}{\sqrt{2} σ / {\vert {h}^{p} \vert}^{2}} ) - erf ( \frac{0 - Re {hx}^{D}}{\sqrt{2} σ / {\vert {h}^{p} \vert}^{2}} ) ) \times ( erf ( \frac{∞ - Im {hx}^{D}}{\sqrt{2} σ / {\vert {h}^{p} \vert}^{2}} ) - erf ( \frac{0 - Im {hx}^{D}}{\sqrt{2} σ / {\vert {h}^{p} \vert}^{2}} ) ) \qquad ( 6 )$$

$$\overline{h} := {h}^{p} - {h}^{D}$$

The bit error function is a function representing an expected value of the number of bit errors determined according to a value of h^{p}, a value of σ (or SNR), a value of h^{D}, a position of x^{D}, and a modulation scheme. The bit error function is: E[number of bit errors]=f (h^{p}; σ, h^{D}, position of x^{D}, modulation scheme). The bit error function accurately represents an expected value of the number of bit errors for an estimated value of the channel.

The processing unit 12 applies the training data 11a in which a value of σ (or SNR), a value of h^{D}, a position of x^{D}, and a modulation method are known to the bit error function. Furthermore, the processing unit 12 calculates E[number of bit errors] for a plurality of values of h^{p} around h^{D}. By doing so, a value of the channel in which E[number of bit errors] is minimized is determined.

In FIG. 1, an example of a calculation result of an expected value of E[number of bit errors] is illustrated by a plurality of sample points. In calculation results 15a and 15b, “Re hp−hD” represents the difference between a real part of h^{p} and a real part of h^{D}, and “Im hp−hD” represents the difference between an imaginary part of h^{p} and an imaginary part of h^{D}. “E[Number of BE]” represents an expected value of the number of bit errors. The calculation result 15b is a result of viewing the calculation result 15a from another angle.

In the example of the calculation result 15b, a sample point 16 represents h^{Emin} among a plurality of values of h^{p}. h^{Emin} at the sample point 16 is different from h^{p} at which h^{p}−h^{D} is 0. That is to say, h^{Emi}≠h^{D}.

If the training data 11a include data corresponding to 1000 resource blocks, for example, an expected value of E[number of bit errors] is calculated for n=14×12×1000 symbols. The shape of a set of sample points varies depending on the difference in the value of σ, the value of h^{D}, the position of x^{D}, or modulation scheme between symbols.

Step S2: The processing unit 12 determines a correction value (a*(h^{p}, σ)) for a certain estimated value (h^{p}) of the channel using a second function (hereinafter, indicated by a function a*(h, σ)). The function a*(h, σ) is a function representing a correction value whose product with a true value (h^{D}) of the channel is h^{Emin}.

An estimated value (h^{p}) of the channel is obtained from a trained machine learning model that estimates the true value (h^{D}) of the channel. For example, as illustrated in FIG. 4, the machine learning model is a DNN-based machine learning model that obtains the matrix H^{p} by regarding the matrix H^{ls} as a low-resolution image and performing high-resolution processing. The machine learning model is trained so that the Euclidean distance (∥H^{D}−H^{p}∥₂) between the matrix H^{p} and the matrix H^{D} representing the true value of the channel is minimized.

As the machine learning model, for example, a DNN such as a convolutional neural network (CNN), a recurrent neural network (RNN), or a Transformer may be used. Information regarding the machine learning model may be stored in the storage unit 11. For example, a value of a parameter such as a weight or a bias for each layer of the DNN is stored as the information regarding the machine learning model.

The processing unit 12 determines the function a*(h, σ) based on a value regarding noise in a propagation path of the transmission signal (for example, variance (σ²)) and a value of h^{Emin} corresponding to a value of h^{D}. The value regarding the noise and the value of h^{Emin} corresponding to the value of h^{D} are obtained from the calculation result by the process of step S1.

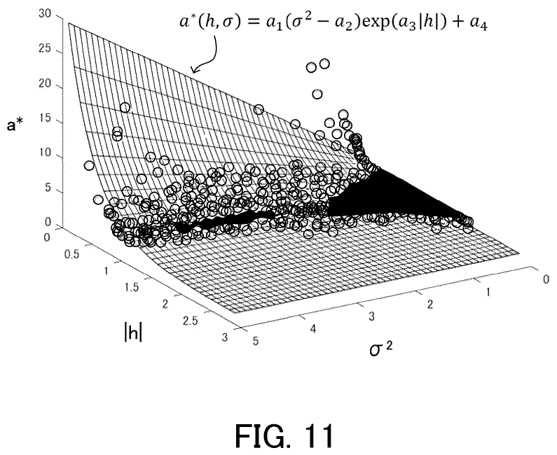

As the function a*(h, σ), for example, a*(h, σ)=a₁ (σ²−a₂)exp(a₃|h|)+a₄ may be used. a₁ to a₄ are fitting parameters. A more specific determination example of the function a*(h, σ) will be described later (see FIG. 11).

Step S3: The processing unit 12 multiplies the estimated value (h^{p}) of the channel by the correction value (a*(h^{p}, σ)) determined in the process of step S2 to correct the estimated value.

Thus, the processing by the channel estimation method is completed. The processing unit 12 may restore a value of the transmission signal (x^{ZF}) by Expression (2) using the corrected channel estimation value obtained in the process of step S3.

According to the above channel estimation method, the value (h^{Emin}) of the channel that minimizes an expected value of the number of bit errors is determined in advance. Furthermore, the correction value a*(h^{p}, σ) for the estimated value (h^{p}) of the channel is determined using the function a*(h, σ) representing a correction value whose product with the true value (h^{D}) of the channel is h^{Emin}. As a result, an increase in the number of bit errors due to the difference between h^{D} and h^{Emin} is suppressed and the number of bit errors is reduced. Furthermore, by using the predetermined function a*(h, σ), it is possible to suppress a calculation load when correcting an estimated value of a channel.

### Second Embodiment

A second embodiment will now be described.

An information processing apparatus 100 according to the second embodiment finds an estimated value of a channel capable of reducing the number of bit errors. The information processing apparatus may be a client apparatus or a server apparatus. The information processing apparatus 100 may be referred to as a computer.

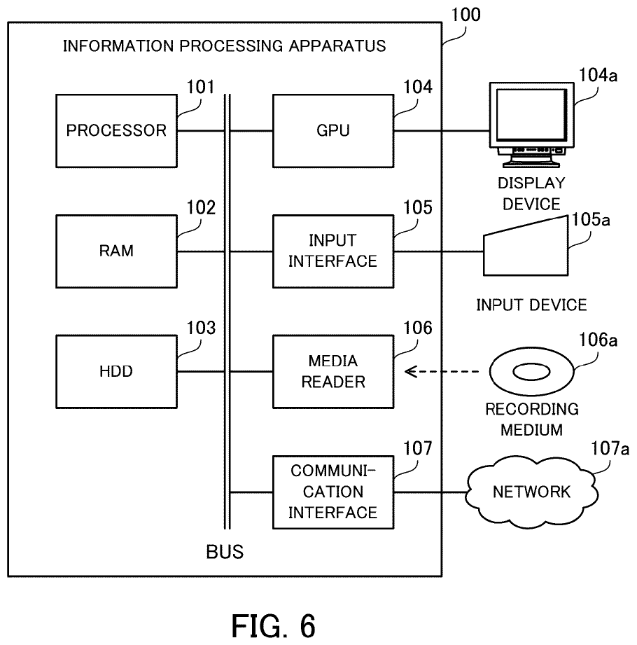

FIG. 6 is a block diagram illustrative of an example of hardware of the information processing apparatus.

The information processing apparatus 100 includes a processor 101, a random access memory (RAM) 102, a hard disk drive (HDD) 103, a graphics processing unit (GPU) 104, an input interface 105, a media reader 106, and a communication interface 107, which are connected to a bus. The processor 101 corresponds to the processing unit 12 of the first embodiment. The RAM 102 or the HDD 103 corresponds to the storage unit 11 of the first embodiment.

The processor 101 is a processor, such as a GPU or a central processing unit (CPU), including an arithmetic circuit that executes instructions of a program. The processor 101 loads at least a part of a program and data stored in the HDD 103 into the RAM 102 and executes the program. The processor 101 may include a plurality of processor cores. Furthermore, the information processing apparatus 100 may include a plurality of processors. A processor that executes a certain process among a plurality of processes by the information processing apparatus 100 may be different from a processor that executes a process different from the certain process among the plurality of processes. In addition, the processor may be referred to as processor circuitry. A set of a plurality of processors (multiprocessor) may be referred to as a “processor”.

The RAM 102 is a volatile semiconductor memory that temporarily stores a program to be executed by the processor 101 and data to be used for calculation by the processor 101. The information processing apparatus 100 may include a volatile memory of a type other than a RAM.

The HDD 103 is a non-volatile storage that stores software programs, such as an operating system (OS), middleware, and application software, and data. The information processing apparatus 100 may include another type of non-volatile storage such as a flash memory or a solid state drive (SSD).

The GPU 104 performs image processing in cooperation with the processor 101 and outputs an image to a display device 104a connected to the information processing apparatus 100. The display device 104a is, for example, a cathode ray tube (CRT) display, a liquid crystal display, an organic electro luminescence (EL) display, or a projector. Another type of output device, such as a printer, may be connected to the information processing apparatus 100.

Furthermore, the GPU 104 may be used as a general purpose computing on graphics processing unit (GPGPU). The GPU 104 may execute a program in response to an instruction from the processor 101. The information processing apparatus 100 may include a volatile semiconductor memory other than the RAM 102 as a GPU memory.

The input interface 105 accepts an input signal from an input device 105a connected to the information processing apparatus 100. The input device 105a is, for example, a mouse, a touch panel, or a keyboard. A plurality of input devices may be connected to the information processing apparatus 100.

The media reader 106 is a reading device that reads a program and data recorded in a recording medium 106a. The recording medium 106a is, for example, a magnetic disk, an optical disc, or a semiconductor memory. The magnetic disk includes a flexible disk (FD) and an HDD. The optical disc includes a compact disc (CD) and a digital versatile disc (DVD). The media reader 106 copies the program and data read from the recording medium 106a to another recording medium such as the RAM 102 or the HDD 103. The read program may be executed by the processor 101.

The recording medium 106a may be a portable recording medium. The recording medium 106a may be used for distributing the program and data. Furthermore, the recording medium 106a and the HDD 103 may be referred to as a computer-readable recording medium.

The communication interface 107 communicates with other information processing apparatuses via a network 107a. The communication interface 107 may be a wired communication interface connected to a wired communication device, such as a switch or a router, or may be a wireless communication interface connected to a wireless communication device, such as a base station or an access point.

The functions of the information processing apparatus 100 will now be described.

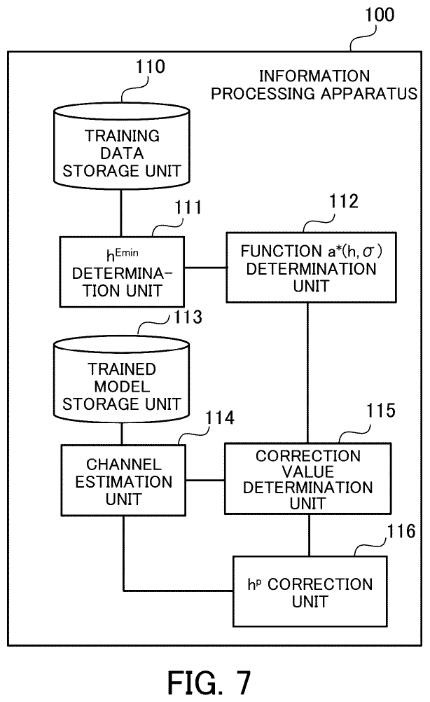

FIG. 7 is a block diagram illustrative of an example of the functions of the information processing apparatus.

The information processing apparatus 100 includes a training data storage unit 110, an h^{Emin} determination unit 111, a function a*(h, σ) determination unit 112, a trained model storage unit 113, a channel estimation unit 114, a correction value determination unit 115, and an h^{p} correction unit 116.

The training data storage unit 110 and the trained model storage unit 113 are implemented using, for example, a storage area secured in the RAM 102 or the HDD 103. The h^{Emin} determination unit 111, the function a*(h, σ) determination unit 112, the channel estimation unit 114, the correction value determination unit 115, and the h^{p} correction unit 116 are implemented using, for example, a program module executed by the processor 101.

The training data storage unit 110 stores training data. The training data include, for example, a value regarding noise in a propagation path of a transmission signal, a true value of a channel, a position of the transmission signal on a complex plane, and a modulation scheme.

The h^{Emin} determination unit 111 determines h^{Emin} that is a value of the channel at which an expected value of the number of bit errors (E[number of bit errors]) is minimized. The h^{Emin} determination unit 111 determines h^{Emin} by applying the above training data to the bit error function described in the first embodiment and calculating E [number of bit errors] for a plurality of values of h^{p} around h^{D}.

The function a*(h, σ) determination unit 112 determines the function a*(h, σ). The function a*(h, σ) is a function representing a correction value whose product with the true value (h^{D}) of the channel is h^{Emin}. The function a*(h, σ) determination unit 112 determines the function a*(h, σ) based on a value of h^{Emin} corresponding to variance (σ²) and a value of h^{D}. The value of h^{Emin} corresponding to the variance (σ²) and the value of h^{D} is obtained from a calculation result by the h^{Emin} determination unit 111.

The trained model storage unit 113 stores information regarding a trained machine learning model. As the machine learning model, for example, a DNN, such as a CNN, an RNN, or a transformer, may be used.

In the case of performing channel estimation in the OFDM scheme, the machine learning model is, for example, a DNN-based machine learning model that obtains a matrix H^{p} by regarding the matrix H^{ls} illustrated in FIG. 4 as a low-resolution image and performing high-resolution processing. The machine learning model is trained so that the Euclidean distance (∥H^{D}−H^{p}∥₂) between the matrix H^{p} and a matrix H^{D} representing the true value of the channel is minimized. The information regarding the trained machine learning model includes, for example, values of parameters such as a weight and a bias for each layer of the DNN.

The channel estimation unit 114 estimates h^{p} using the trained machine learning model. For example, the channel estimation unit 114 inputs the matrix H^{ls} to the machine learning model and acquires the matrix Hₚ from the machine learning model. The matrix H^{p} includes h^{p} of each symbol.

The correction value determination unit 115 uses the function a*(h, σ) to determine a correction value (a*(h^{p}, σ)) for h^{p} obtained by the channel estimation unit 114.

The h^{p} correction unit 116 corrects h^{p} by multiplying h^{p} estimated by the channel estimation unit 114 by the correction value determined by the correction value determination unit 115.

(Reason Why h^{Emin} is Different from h^{D})

As described in the first embodiment, a value (h^{Emin}) of the channel at which an expected value of the number of bit errors is minimized may be different from h^{D}. The reason will be described below.

FIG. 8 illustrates the relationship between a transmission signal and a restored transmission signal. FIG. 8 illustrates an example in which a modulation scheme is 16 quadrature amplitude modulation (16QAM).

A restored transmission signal (x^{ZF}) is expressed by Expression (2). An expected value of the number of bit errors is minimized when h^{p}=ah^{D} where a>0. Expression (2) is expressed as Expression (7) using a.

$${x}^{ZF} = \frac{1}{a} {x}^{D} + \frac{n}{{ah}^{D}} \qquad ( 7 )$$

However, when a<1, deviation of a value of the restored transmission signal (x^{ZF}) from a value of the transmission signal (x^{D}) increases according to Expression (7). In addition, the magnitude of the noise also increases. Therefore, the expected value of the number of bit errors deteriorates.

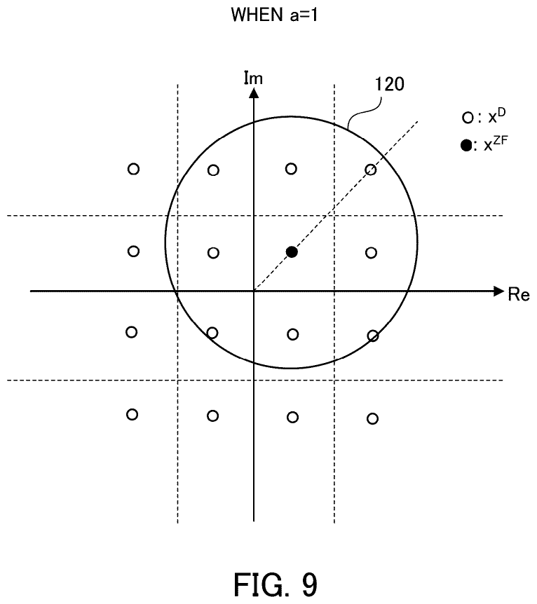

FIG. 9 illustrates the relationship between a transmission signal and a restored transmission signal at the time of a=1.

When a=1, h^{p}=h^{D} and a value of the restored transmission signal (x^{ZF}) matches a value of the transmission signal (x^{D}). In FIG. 9, a circle 120 represents the magnitude of variance (σ²) by x^{ZF}. In the 16QAM, the variance of x^{ZF} increases as the distance from an origin where values of an imaginary part and a real part are both 0 increases.

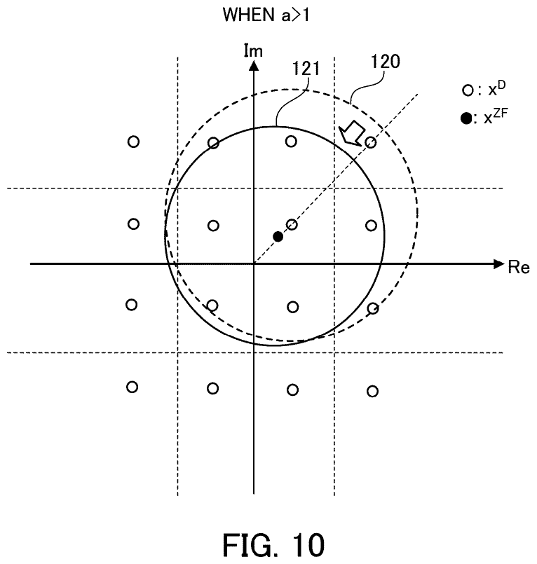

FIG. 10 illustrates the relationship between a transmission signal and a restored transmission signal at the time of a>1.

When a>1, deviation of a value of x^{ZF} from a value of x^{D} increases, but variance represented by a circle 121 becomes smaller than that at the time of a=1, so that the magnitude of the noise decreases. Therefore, an expected value of the number of bit errors may be smaller than that at the time of a=1.

For this reason, a value (h^{Emin}) of the channel at which an expected value of the number of bit errors is minimized may be different from h^{D}.

(Example of Generating Function a*(h, σ))

FIG. 11 illustrates an example of generating the function a*(h, σ). In FIG. 11, an example of calculation results of a*corresponding to the absolute value of h^{D} (indicated by |h|) and a value of σ² is represented by a plurality of sample points. a*is a scalar value that satisfies h^{D}×a*=h^{Emin}.

A value of h^{Emin} corresponding to the values of the variance (σ²) and h^{D} is obtained from a calculation result by the h^{Emin} determination unit 111. a*is obtained from a*=h^{Emin}/h^{D}.

The function a*(h, σ) is obtained by performing function fitting on the set of sample points illustrated in FIG. 11. As the function a*(h, σ), for example, a*(h, σ)=a₁ (σ²−a₂) exp (a₃|h|)+a₄ may be used. a₁ to a₄ are fitting parameters. FIG. 11 illustrates the function a*(h, σ) after the fitting. In the fitting result of FIG. 11, a root mean squared error (RMSE) is 0.272, which represents the set of sample points relatively well.

### (Example of Correcting Estimated Value of Channel)

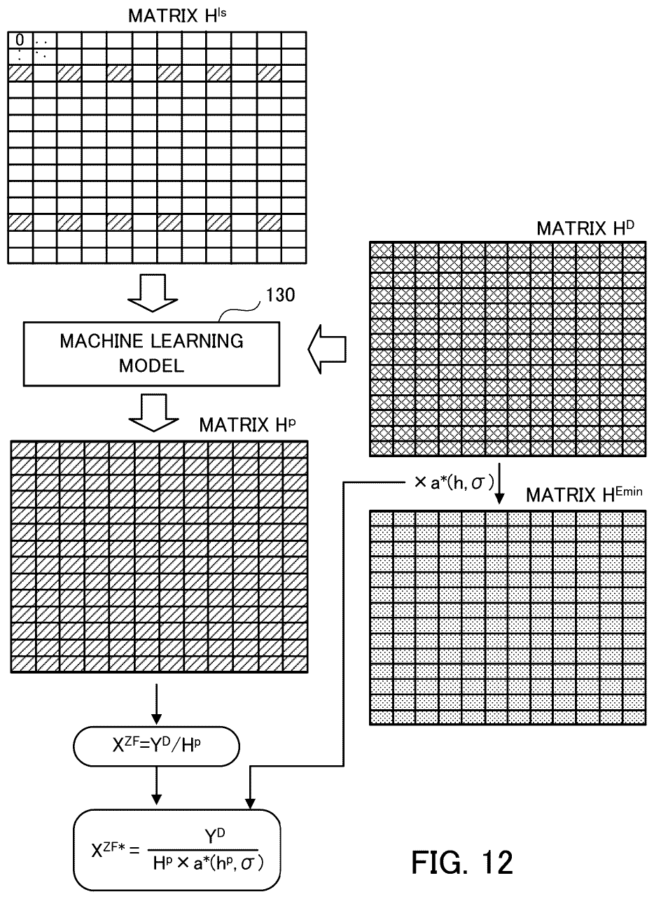

FIG. 12 illustrates an example of correcting an estimated value of a channel.

The channel estimation unit 114 acquires the matrix H^{p} by inputting the matrix H^{ls} illustrated in FIG. 4 to a trained machine learning model 130. Because the machine learning model 130 is trained so that the Euclidean distance between the matrix H^{p} and the matrix H^{D} is minimized, a value of h^{p} of each symbol included in the matrix H^{p} is approximately equal to a value of h^{D}.

Because the function a*(h, σ) represents a correction value whose product with the true value (h^{D}) of the channel is h^{Emin}, a matrix H^{Emin} by h^{Emin} is obtained by multiplying each h^{D} of the matrix H^{D} by a value of the function a*(h, σ) corresponding to each h^{D} of the matrix H^{D}.

When the transmission signal is restored, h^{D} is unknown. Therefore, correction is performed by multiplying each h^{p} of the matrix H^{p} by a value (correction value a*(h^{p}, σ)) of the function a*(h, σ) corresponding to each h^{p} of the matrix H^{p}. As illustrated in FIG. 12, a matrix X^{ZF} of the transmission signal restored using the matrix H^{p} before correction is expressed as X^{ZF}=Y^{D}/H^{p}. On the other hand, a matrix X^{ZF}*of the transmission signal restored using a matrix H^{p}×a*(h^{p}, σ) of the corrected transmission signal is expressed as X^{ZF}*=Y^{D}/H^{p}×a*(h^{p}, σ).

### (Procedure for Estimation Method)

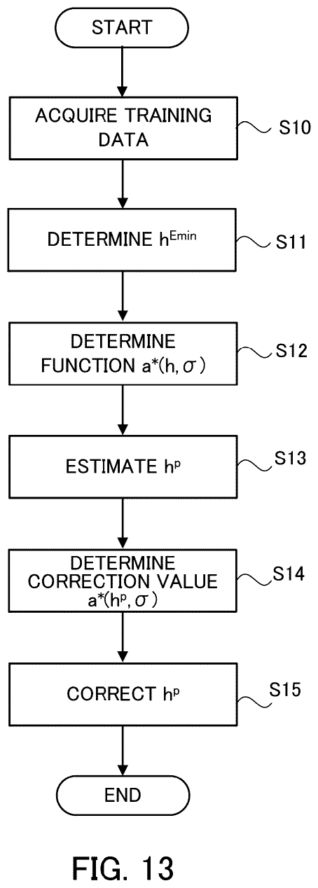

FIG. 13 is a flow chart illustrative of a processing procedure of a channel estimation method according to a second embodiment.

Step S10: The information processing apparatus 100 acquires training data. The training data may be acquired from the recording medium 106a or may be acquired (received) from another computer via the network 107a. The acquired training data is stored in the RAM 102 or the HDD 103.

Step S11: The information processing apparatus 100 determines h^{Emin} by applying the above training data to a bit error function and calculating E[number of bit errors] for a plurality of values of h^{p} around h^{D}.

Step S12: The information processing apparatus 100 determines a function a*(h, σ) based on a calculation result of h^{Emin}, for example, by the method illustrated in FIG. 11.

Step S13: The information processing apparatus 100 estimates h^{p} using a trained machine learning model.

Step S14: The information processing apparatus 100 determines a correction value (a*(h^{p}, σ)) for h^{p} obtained by the channel estimation unit 114 using the function a*(h, σ).

Step S15: The information processing apparatus 100 corrects h^{p} by multiplying h^{p} estimated in the process of step S13 by a*(h^{p}, σ) determined in the process of step S14.

For example, the information processing apparatus 100 may store a corrected value of h^{p} of each symbol of the matrix H^{p} as illustrated in FIG. 12 in the RAM 102 or the HDD 103. The corrected value of h^{p} of each symbol may be transmitted to another computer via the network 107a.

Thus, the processing of the channel estimation method according to the second embodiment is completed. The information processing apparatus 100 may restore a transmission signal (x^{ZF}) using the corrected h^{p}.

According to the channel estimation method according to the second embodiment, the function a*(h, σ) representing the correction value whose product with the true value (h^{D}) of a channel is h^{Emin} is determined in advance and the correction value a*(h^{p}, σ) for the estimated value (h^{p}) of the channel is determined using the function a*(h, σ). As a result, an increase in the number of bit errors due to the difference between h^{D} and h^{Emin} is suppressed and the number of bit errors is reduced. Furthermore, by using the predetermined function a*(h, σ), it is possible to suppress a calculation load when correcting the estimated value of the channel.

### (Evaluation Result)

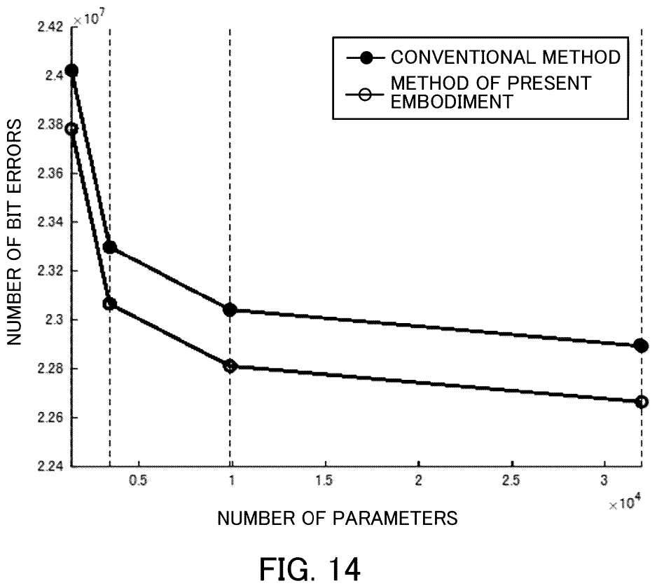

FIG. 14 illustrates an evaluation result indicative of the relationship between the number of parameters of the machine learning model and the number of bit errors. In FIG. 14, an evaluation result obtained in the case of applying the conventional method of, as described above, regarding the matrix H^{ls} as a low-resolution image and obtaining the matrix H^{p} by performing high-resolution processing using a DNN-based machine learning model and an evaluation result obtained in the case of applying the method of the present embodiment are compared.

As illustrated in FIG. 14, the number of bit errors is smaller when the method of the present embodiment is applied than when the conventional method is applied. That is to say, the number of bit errors is reduced by applying the method of the present embodiment.

### (Modification)

The machine learning model may be trained using a function obtained by approximating the bit error function as a loss function based on a simulation result (for example, the calculation results 15a and 15b illustrated in FIG. 1) using the above bit error function. For example, a function g given by Expression (8) may be used.

$$g ( Re \overline{h} , Im \overline{h} ) = - {a}_{0} cos ( {a}_{1} Re \overline{h} ) cos ( {a}_{1} Im \overline{h} ) exp ( - {a}_{2} ( Re {\overline{h}}^{2} ) - {{a}_{2} ( Im \overline{h} )}^{2} ) + {a}_{3} {Re ( \overline{h} )}^{2} + {{a}_{3} ( Im \overline{h} )}^{2} + {a}_{4} \qquad ( 8 )$$

$$\overline{h} := {h}^{p} - {h}^{D} ,$$

$${a}_{i} = {b}_{i} \times SNR + {c}_{i}$$

The function g is an extension of the Easom function. bᵢ and cᵢ are fitting parameters. The machine learning model is trained so that the sum total of the function g determined for each SNR and each modulation scheme is minimized.

Because a value of the function g is minimized when h^{p}=h^{D}, correction using the function a*(h, σ) is applicable as in the channel estimation method according to the second embodiment.

In one aspect, the number of bit errors is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to perform a process comprising:
determining, by using a first function representing an expected value of a number of bit errors in a transmission signal restored from a received signal using an estimated value of a channel, a first value of the channel that minimizes the expected value; and
determining a first correction value for a first estimated value of the channel using a second function for obtaining a correction value whose product with a true value of the channel is the first value.

2. The non-transitory computer-readable recording medium according to claim 1, wherein the first estimated value is corrected by multiplying the first estimated value by the first correction value.

3. The non-transitory computer-readable recording medium according to claim 1, wherein the second function is determined based on the first value corresponding to the true value and a value regarding a noise in a propagation path of the transmission signal.

4. The non-transitory computer-readable recording medium according to claim 1, wherein a value of the first function is determined according to the estimated value, a value regarding a noise in a propagation path of the transmission signal, the true value, a position of the transmission signal on a complex plane, or a modulation scheme.

5. The non-transitory computer-readable recording medium according to claim 1, wherein the first estimated value is acquired from a trained machine learning model that estimates the true value.

6. A channel estimation method comprising:
determining, by a processor, by using a first function representing an expected value of a number of bit errors in a transmission signal restored from a received signal using an estimated value of a channel, a first value of the channel that minimizes the expected value; and
determining, by the processor, a first correction value for a first estimated value of the channel using a second function for obtaining a correction value whose product with a true value of the channel is the first value.

7. An information processing apparatus comprising:
a memory; and
a processor coupled to the memory and the processor configured to:
determine, by using a first function representing an expected value of a number of bit errors in a transmission signal restored from a received signal using an estimated value of a channel, a first value of the channel that minimizes the expected value; and
determine a first correction value for a first estimated value of the channel using a second function for obtaining a correction value whose product with a true value of the channel is the first value.
